(19) United States
(12) Patent Application Publication
(10) Pub. No.: US 2012/0062079 A1
(43) Pub. Date: Mar. 15, 2012

(54) Rotor for Motor

(76) Inventors: Alex HORNG, Kaohsiung (TW); Duo-Nian SHAN, Kaohsiung (TW); Zhe-Hao WU, Kaohsiung (TW)

(21) Appl. No.: 12/938,442

(22) Filed: Nov. 3, 2010

(30) Foreign Application Priority Data
Sep. 15, 2010 (TW) 099131278

(51) Int. Cl. H02K 7/14

(52) U.S. Cl. 310/75 R

(57) ABSTRACT

A rotor for a motor includes a hub having a through-hole. A shaft extends through the through-hole and includes an outer periphery having a reduced section, wherein the reduced section has two end walls in an axial direction of the motor. The engaging member includes a hole through which the shaft extends. The engaging member is tightly engaged with the reduced section while tightly pressing against the two end walls of the reduced section. The engaging member is a resilient, continuous annular member free of grooves and notches. When the rotor is mounted in a motor, axial vibration of the hub relative to the shaft is reduced, and leakage of lubricating oil in the bearings of the motor is prevented.

### BACKGROUND OF THE INVENTION

1. Field of the Invention

The present invention relates to a rotor for a motor and, more particularly, to a rotor that can reduce axial vibration of a hub relative to a shaft and that can avoid leaking of lubricating oil received in the bearings of a motor.

2. Description of the Related Art

With reference to FIG. 1, a conventional rotor 7 for a motor includes a hub 71, a shaft 72, and a metal C-clip 73. The hub 71 includes a through-hole 711. An inner periphery of the through-hole 711 has a planar face 712 and a first stop face 713. The shaft 72 includes an outer periphery having an annular engaging groove 721, a chamfered face 722, and a second stop face 723. The metal C-clip 73 has an opening 731 in a side thereof.

With reference to FIGS. 1 and 2, in assembly of the rotor 7, the shaft 72 is extended through the through-hole 711 with the chamfered face 722 abutting the planar face 712, allowing joint rotation of the hub 71 and the shaft 72. The second stop face 723 abuts the first stop face 713. Thus, the shaft 72 is prevented from disengaging from the hub 71 in an axial direction when the metal C-clip 73 is engaged in the engaging groove 721 due to provision of the opening 731.

The rotor 7 can be utilized in a motor 8 having a housing 81, a stator 82, and a magnet 83. The stator 82 is fixed in the housing 81. The magnet 83 is received in the housing 81. The shaft 72 of the rotor 7 is rotatably received in the housing 81 by two bearings 84. The magnet 83 is fixed to the shaft 72. The stator 82 can drive the magnet 83 and the shaft 72 to rotate through magnetic force, causing synchronous rotation of the hub 71.

To allow easy insertion of the metal C-clip 73 into the engaging groove 721, an axial length L1 of the engaging groove 721 along the axis of the shaft 72 is larger than a thickness t1 of the metal C-clip 73. Thus, an axial gap extending along the axis exists between the metal C-clip 73 and an end wall of the engaging groove 721. As a result, the hub 71 is liable to move axially relatively to the shaft 72 when the rotor 7 rotates. Furthermore, the metal C-clip 73 continuously impinges on a top face of the hub 71 and generates noise, adversely affecting the operation of the motor 8.

Furthermore, the lubricating oil received in the bearings 84 of the motor 8 move upward through the through-hole 711 of the hub 71 when the rotor 7 rotates. However, the metal C-clip 73 is not a continuous annular member, and there is an axial gap between the metal C-clip 73 and the end wall of the engaging groove 721. Thus, the lubricating oil received in the bearings 84 are liable to leak via the gap and the opening 731, shortening the service life of the motor 8.

FIG. 3 shows another conventional rotor 9 for a motor. The rotor 9 includes a hub 91, a shaft 92, and a retainer 93. The hub 91 includes a through-hole 911. An inner periphery of the through-hole 911 has a planar face 912 and a first stop face 913. The shaft 92 includes an outer periphery having an annular engaging groove 921, a chamfered face 922, and a second stop face 923. The retainer 93 has a through-hole 931. A plurality of resilient retaining plates 932 is formed on an inner periphery of the through-hole 931.

With reference to FIGS. 3 and 4, in assembly of the rotor 9, the shaft 92 is extended through the through-hole 911 with the chamfered face 922 abutting the planar face 912, allowing joint rotation of the hub 91 and the shaft 92. The second stop face 923 abuts the first stop face 913. Furthermore, each resilient retaining plate 932 is engaged in the engaging groove 921 of the shaft 92, preventing the shaft 92 from disengaging from the hub 91 in an axial direction.

When the retainer 93 engages with the shaft 92, the shaft 92 presses against each resilient retaining plate 932, deforming each resilient retaining plate 932 and urging each resilient retaining plate 932 into the engaging groove 921. Although the axial gap between each resilient retaining plate 932 and the end wall of the engaging groove 921 along the axis of the shaft 92 is reduced, a space must be preserved in the engaging groove 921 to allow deformation of each resilient retaining plate 932. Furthermore, the engagement tolerance between the engaging groove 921 and the retainer 93 is inevitable during manufacturing. The axial gap between each resilient retaining plate 932 and the end wall of the engaging groove 921 cannot be completely eliminated. Thus, the hub 91 moves axially relatively to the shaft 92 when the rotor 9 rotates, resulting in noise. Furthermore, the retainer 93 is made of rigid material such as metal and thus liable to fatigue after a period of time. The axial gap between each resilient retaining plate 932 and the end wall of the engaging groove 921 becomes larger, causing more noise and adversely affecting the operation of the motor 8.

Furthermore, although the retainer 93 is annular, a slit 933 exists between two adjacent resilient retaining plates 932 formed on the inner periphery of the through-hole 931 of the retainer 93. Thus, the retainer 93 is not continuous in the resilient retaining plates 932 after the retainer 93 is engaged in the engaging groove 921. As a result, the lubricating oil in the bearings 94 of the motor 9 is liable to leak via the slits 933, shortening the service life of the motor 8.

### SUMMARY OF THE INVENTION

An objective of the present invention is to provide a rotor for a motor that provides buffering effect between a hub and a shaft to reduce axial vibration of the hub relative to the shaft.

Another objective of the present invention is to provide a rotor for a motor that prevents leaking of the lubricating oil received in the bearings of the motor.

The present invention fulfills the above objectives by providing, in a preferred form, a rotor for a motor including a hub having a through-hole. A shaft extends through the through-hole and includes an outer periphery having a reduced section, wherein the reduced section has two end walls in an axial direction of the motor. The engaging member includes a hole through which the shaft extends. The engaging member is tightly engaged with the reduced section while tightly pressing against the two end walls of the reduced section. The engaging member is a resilient, continuous annular member free of grooves and notches.

In preferred forms, the hole of the engaging member has a diameter smaller or equal to an outer diameter of the reduced section of the shaft. The engaging member has a thickness along an axis of the shaft equal to or larger than a length of the reduced section along the axis of the shaft. A maximum diameter of the engaging member is larger than a diameter of the through-hole of the hub. The hub includes a top face in which the through-hole is formed. The engaging member abuts the top face. A concavity is formed in an adjoining area between the top face and the through-hole. The engaging member is received in the concavity.

In a preferred form, the reduced section is located adjacent to an end of the shaft. The concavity has a depth along the axis of the shaft. The depth of the concavity is larger than a maximum spacing between an end face of the end of the shaft and the reduced section.

The present invention will become clearer in light of the following detailed description of illustrative embodiments of this invention described in connection with the drawings.

### BRIEF DESCRIPTION OF THE DRAWINGS

The illustrative embodiments may best be described by referring to the accompanying drawings where:

FIG. 1 shows an exploded, perspective view of a conventional rotor.

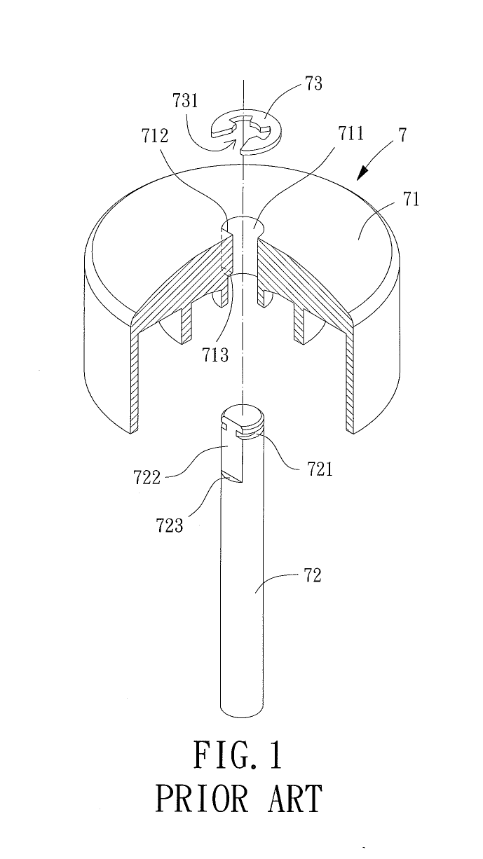

FIG. 2 shows a cross sectional view of a motor using the rotor of FIG. 1.

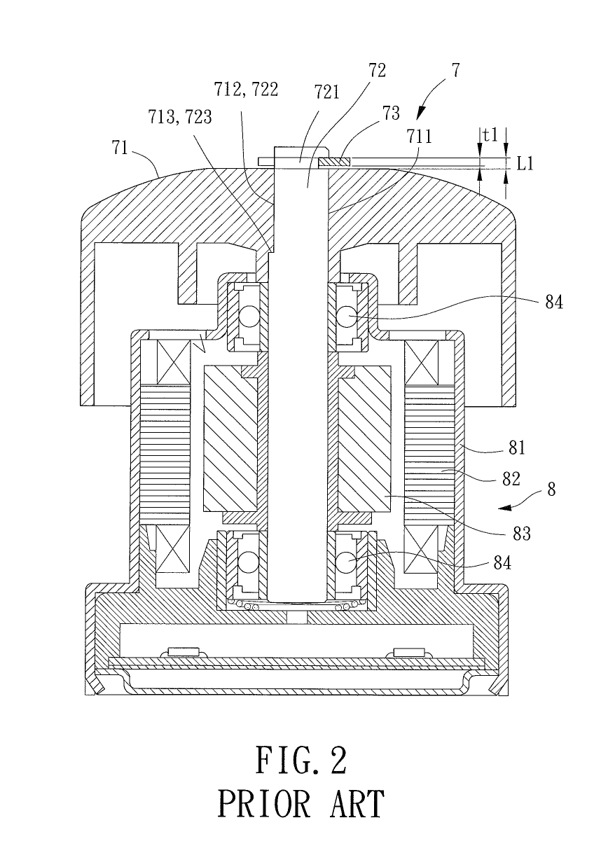

FIG. 3 shows an exploded, perspective view of another conventional rotor.

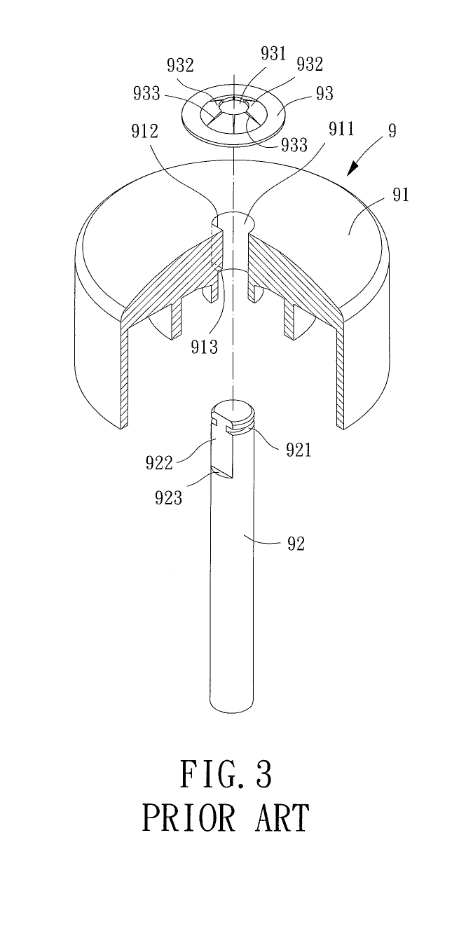

FIG. 4 shows a cross sectional view of a motor using the rotor of FIG. 3.

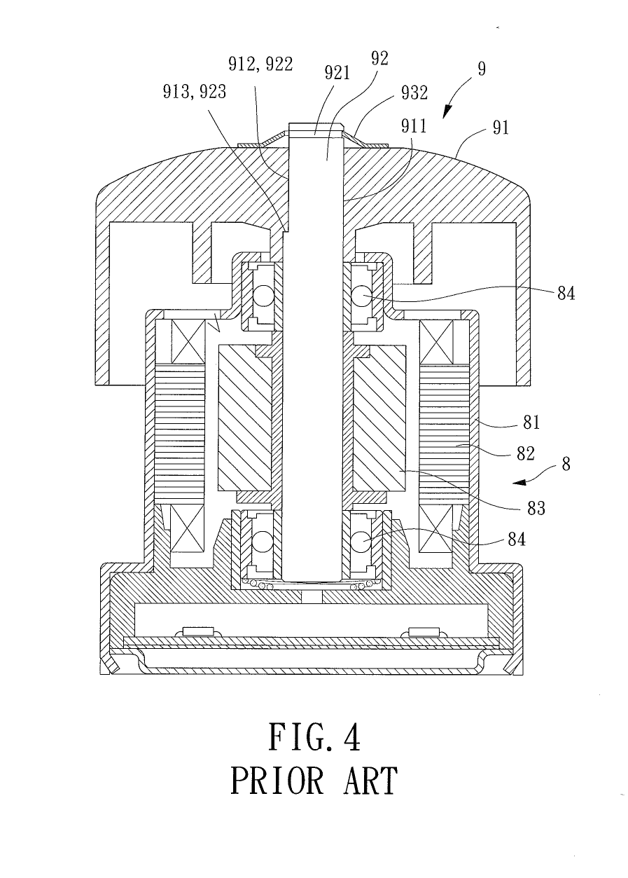

FIG. 5 shows an exploded, perspective view of a rotor of an embodiment according to the preferred teachings of the present invention.

FIG. 6 shows a cross sectional view of the rotor of FIG. 5.

FIG. 7 shows a cross sectional view of a rotor of a modified embodiment according to the preferred teachings of the present invention.

FIG. 8 shows a cross sectional view of a motor using the rotor of FIG. 6.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions conforming to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “end”, “portion”, “section”, “axial”, “annular”, “spacing”, “length”, “thickness”, and similar terms are used herein, it should be understood that these terms refer only to the structure shown in the drawings as it would appear to a person viewing the drawings and are utilized only to facilitate describing the invention.

### DETAILED DESCRIPTION OF THE INVENTION

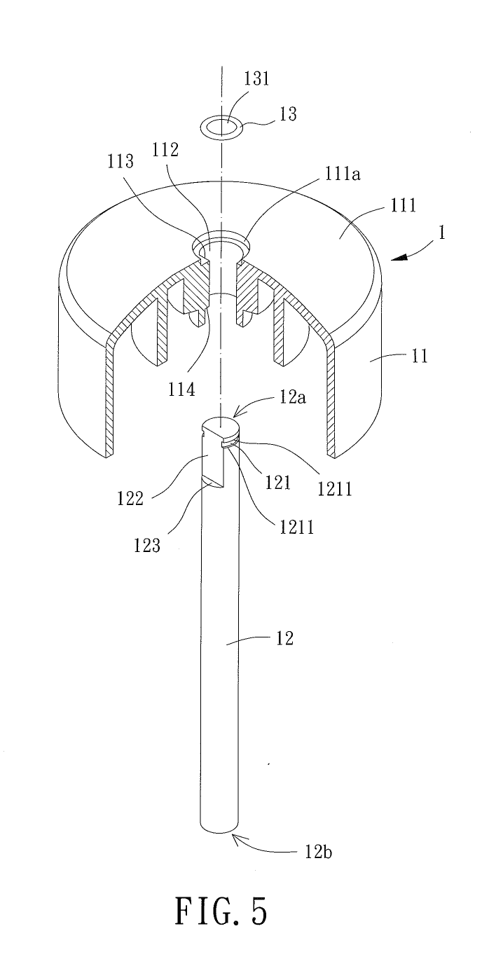

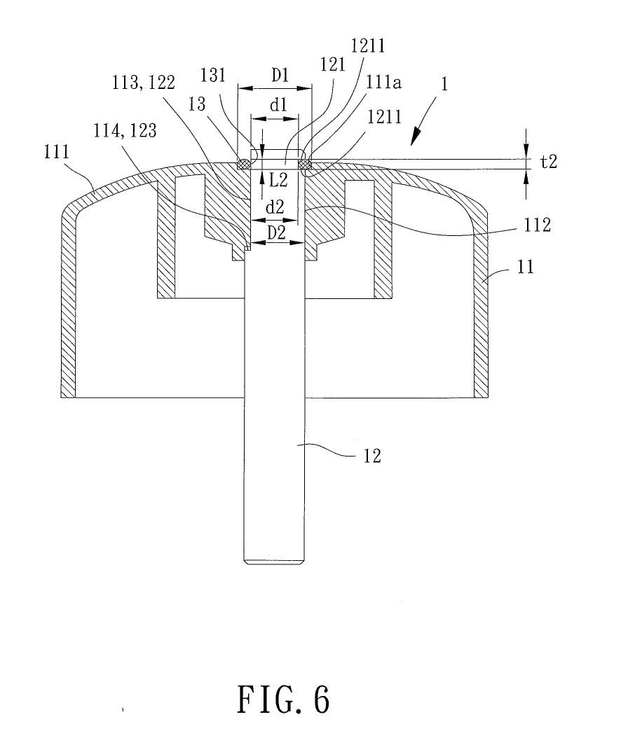

With reference to FIGS. 5 and 6, a rotor 1 for a motor of an embodiment according to the preferred teachings of the present invention includes a hub 11, a shaft 12, and an engaging member 13. The shaft 12 is fixed to the hub 11 through the engaging member 13.

The hub 11 includes a top face 111 having a through-hole 112 extending through the hub 11. The through-hole 112 can be located in a center of the top face 111. An inner periphery of the through-hole 112 includes a planar face 113 and a first stop face 114. The planar face 113 extends parallel to an axis of the through-hole 112. The first stop face 114 extends perpendicularly to the axis of the through-hole 112. However, the shapes of the planar face 113 and the first stop face 114 are not limited to those shown in FIGS. 5 and 6.

The shaft 12 includes a first end 12a and a second end 12b. An outer periphery of the shaft 12 adjacent to the first end 12a includes a reduced section 121, a chamfered face 122, and a second stop face 123. The reduced section 121 may be in the form of a groove and includes two end walls 1211 on an axial direction of the motor. The chamfered face 122 extends parallel to an axis of the shaft 12. The second stop face 123 extends perpendicularly to the axis of the shaft 12. However, the shapes of the chamfered face 122 and the second face 123 are not limited to those shown in FIGS. 5 and 6. The shaft 12 is extended through the through-hole 112 of the hub 11 with the first end 12a of the shaft 12 extending beyond the top face 111. The chamfered face 122 of the shaft 12 abuts the planar face 113 of the hub 11, allowing joint rotation of the hub 11 and the shaft 12. The second stop face 123 abuts the first stop face 114, restraining an axial position of the shaft 12 relative to the hub 11.

The engaging member 13 is resilient and annular, and free of grooves and notches. The engaging member 13 can be made of plastic, rubber, or silicon rubber. The engaging member 13 can have circular, elliptic, or rectangular cross sections. The engaging member 13 has an inner central hole 131 through which the shaft 12 extends. The inner central hole 131 has a diameter d1 smaller or equal to an outer diameter d2 of the reduced section 121 of the shaft 12. The maximum outer diameter D1 of the engaging member 13 is larger than a diameter D2 of the through-hole 112 of the hub 11. The engaging member 13 can be pulled to distend the inner central hole 131, allowing easy passage of the shaft 12. Then, the engaging member 13 restores to its initial shape due to resiliency, mounting the engaging member 13 around the reduced section 121 and preventing the shaft 12 from disengaging from the hub 11. Furthermore, a thickness t2 of the engaging member 13 along the axis of the shaft 12 can be equal to or larger than a length (L2) of the reduced section 121 along the axis of the shaft 12, further enhancing tight contact between the engaging member 13 and the reduced section 121.

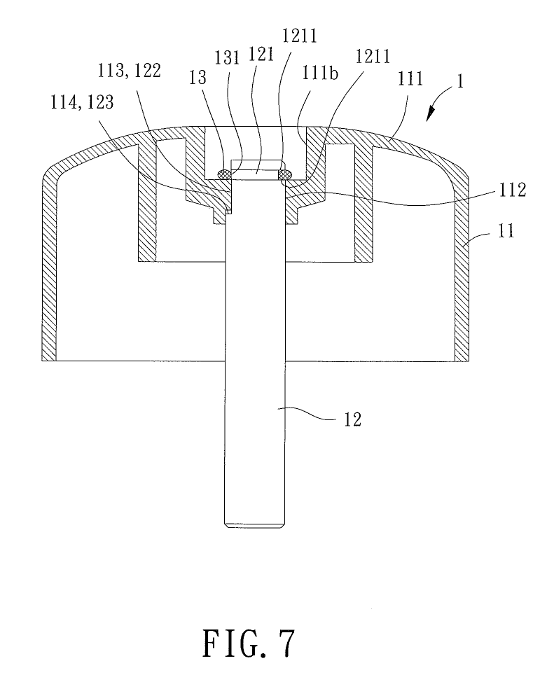

Furthermore, a concavity 111a can be formed in an adjoining area between the top face 111 of the hub 11 and the through-hole 112. When the engaging member 13 is received in the reduced section 121 of the shaft 12, the engaging member 13 is received in the concavity 111a. In a modified embodiment shown in FIG. 7, a depth of the concavity 111b along the axis of the shaft 12 is larger than a maximum spacing between an end face of the first end 12a of the shaft 12 and the reduced section 121. Thus, when the hub 11 is engaged with the shaft 12, the first end 12a of the shaft 12 does not extend beyond the top face 111 of the hub 11, preventing the first end 12a of the shaft 12 from being damaged.

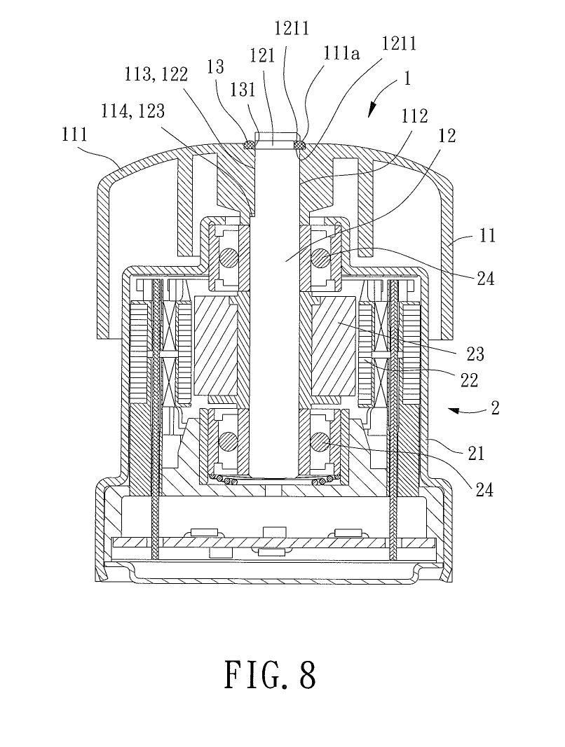

With reference to FIGS. 5, 6, and 8, the rotor 1 according to the preferred teachings of the present invention can be mounted in ordinary motors. In the illustrated embodiment, the rotor 1 is utilized in an axial-flow inner-rotor type motor 2. The motor 2 includes a housing 21, a stator 22, and a magnet 23.

The stator 22 is fixed in the housing 21. The magnet 23 is received in the housing 21. The shaft 12 of the rotor 1 is rotatably received in the housing 21 by at least one bearing 24 (two bearings 24 are used in this embodiment). The magnet 23 is fixed to the shaft 22. The stator 22 can drive the magnet 23 and the shaft 22 to rotate through magnetic force, causing synchronous rotation of the hub 11.

The engaging member 13 squeezes into the reduced section 121 by the resiliency of the engaging member 13 when the engaging member 13 is mounted around the reduced section 121. Thus, the engaging member 13 tightly presses against the end walls 1211 of the reduced section 121, preventing the hub 11 from moving axially relatively to the shaft 12 and avoiding generation of noise. Furthermore, the resilient, continuous engaging member 13 provides a stopping effect by pressing tightly against the shaft 12 and the top face 111, preventing leakage of lubricating oil received in the bearings 24 of the motor 2.

According to the foregoing, the engaging member 13 according to the preferred teachings of the present invention is resilient and continuous. Furthermore, the diameter d1 of the inner central hole 131 is smaller or equal to the outer diameter d2 of the reduced section 121 of the shaft 12. Thus, the engaging member 13 squeezes into the reduced section 121 by the resiliency of the engaging member 13 such that no gaps exist between the engaging member 13 and the reduced section 121. Furthermore, a portion of the engaging member 13 extending beyond the reduced section 121 provides a stopping effect by pressing tightly against the top face 111 of the hub 11, preventing relative axial movement between the hub 11 and the shaft 12 and avoiding generation of noise.

Furthermore, the resilient, continuous engaging member 13 provides a stopping effect by tight pressing against the shaft 12 and the top face 111 when the engaging member 13 is mounted around the reduced section 121, preventing leakage of the lubricating oil received in the bearings 24 of the motor 2.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A rotor for a motor comprising:
a hub including a through-hole;
a shaft extending through the through-hole, with the shaft including an outer periphery having a reduced section, wherein the reduced section has two end walls in an axial direction of the motor; and
an engaging member, with the engaging member being a resilient, continuous annular member free of grooves and notches, with the engaging member including a hole through which the shaft extends, with the engaging member tightly engaged with the reduced section while tightly pressing against the two end walls of the reduced section.

2. The rotor for a motor as claimed in claim 1, with the hole of the engaging member having a diameter smaller or equal to an outer diameter of the reduced section of the shaft.

3. The rotor for a motor as claimed in claim 2, with the engaging member having a thickness along an axis of the shaft, with the reduced section having a length along the axis of the shaft, with the thickness of the engaging member equal to or larger than the length of the reduced section.

4. The rotor for a motor as claimed in claim 1, with the engaging member having a maximum diameter larger than a diameter of the through-hole of the hub.

5. The rotor for a motor as claimed in claim 1, with the hub including a top face, with the through-hole formed in the top face, with the engaging member abutting the top face.

6. The rotor for a motor as claimed in claim 5, with a concavity formed in an adjoining area between the top face and the through-hole, with the engaging member received in the concavity.

7. The rotor for a motor as claimed in claim 6, with the reduced section located adjacent to an end of the shaft, with the concavity having a depth along the axis of the shaft, with the depth of the concavity larger than a maximum spacing between an end face of the end of the shaft and the reduced section.

8. The rotor for a motor as claimed in claim 1, with the engaging member made of plastic, rubber, or silicon rubber.
